(19) United States
(12) Patent Application Publication
(10) Pub. No.: US 2026/0084443 A1
(43) Pub. Date: Mar. 26, 2026

(54) PRINTING APPARATUS

(71) Applicant: CANON KABUSHIKI KAISHA, Tokyo (JP)

(72) Inventors: KENGO NIEDA, Kanagawa (JP); HIROSHI KAWAFUJI, Tokyo (JP); RYOTA IMAI, Kanagawa (JP); TAKUMI OTANI, Kanagawa (JP)

(21) Appl. No.: 19/272,253

(22) Filed: Jul. 17, 2025

(30) Foreign Application Priority Data
Sep. 20, 2024 (JP) 2024-164374

(51) Int. Cl. B41J 11/00; B41J 25/00; B41J 25/34

(52) U.S. Cl. CPC B41J 11/0095; B41J 11/008; B41J 25/001; B41J 25/34

(57) ABSTRACT

The present disclosure is directed to providing a printing apparatus capable of detecting the position of an end portion of a print medium with high accuracy. The printing apparatus includes a conveyance unit, a carriage, a print head including an ejection port array formed of a plurality of ejection ports, a detection unit, and a control unit. In a conveyance direction, a detection range of the detection unit overlaps a portion of an ejection range where liquid is ejected of a range where the ejection port array is formed. During scanning by the carriage in a case where the detection unit detects the position of the end portion of the print medium, the control unit performs control so that liquid is not ejected from an ejection port included in an area overlapping the detection range in the conveyance direction among the plurality of ejection ports constituting the ejection port array.

### BACKGROUND

### Field of the Technology

The present disclosure relates to a printing apparatus.

### Description of the Related Art

In a printing apparatus that performs printing by ejecting liquid from a print head onto a print medium, printing may be performed in which the amount of margins in the width direction of the print medium is reduced to the extent that the margins are visually less noticeable (hereinafter referred to as “micro-margin printing”).

Japanese Patent Laid-Open No. 2017-65131 discloses a printing apparatus that detects an end portion of a print medium with a sensor attached to a print head during print scanning and changes a print start position in the next print scanning according to a detected position to perform micro-margin printing. The printing apparatus in Japanese Patent Laid-Open No. 2017-65131 implements micro-margin printing while reducing wasted printing material (ink).

In micro-margin printing, in order to perform printing on a print medium with high accuracy, it is important to detect the position of an end portion of the print medium with high accuracy during a printing operation. In general, in the case of detecting the position of an end portion of a print medium, the end portion of the print medium is irradiated with light and the reflected light of the light is received.

However, in a case where the light irradiated toward the end portion of the print medium hits an image printed on the print medium, the intensity of the reflected light is reduced, which makes it difficult to detect the position of the end portion of the print medium with high accuracy and also makes it difficult to perform printing on the print medium with high accuracy.

### SUMMARY

The present disclosure is directed to providing a printing apparatus capable of detecting the position of an end portion of a print medium with high accuracy.

A printing apparatus comprises a conveyance unit configured to convey a print medium in a conveyance direction, a carriage configured to perform scanning in a scanning direction intersecting the conveyance direction, a print head mounted on the carriage and including an ejection port array in which a plurality of ejection ports for ejecting liquid are arranged in the conveyance direction to perform printing by ejecting liquid from the ejection ports onto the print medium conveyed by the conveyance unit, a detection unit provided on the carriage and configured to detect a position of an end portion of the print medium, and a control unit configured to control driving of the print head while the carriage performs scanning in the scanning direction, wherein in the conveyance direction, a detection range of the detection unit overlaps a portion of an ejection range in which liquid is ejected of a range in which the ejection port array is formed, and during scanning by the carriage in a case where the detection unit detects the position of the end portion of the print medium, the control unit performs control so that liquid is not ejected from an ejection port included in an area overlapping the detection range in the conveyance direction among the plurality of ejection ports constituting the ejection port array.

Features of the present disclosure will become apparent from the following description of embodiments with reference to the attached drawings. The following description of embodiments is described by way of example.

### BRIEF DESCRIPTION OF THE DRAWINGS

FIG. 1 is an external perspective view of a printing apparatus applicable to an embodiment;

FIG. 2 is an explanatory diagram explaining an internal mechanism of the printing apparatus;

FIG. 3A is a schematic plan view of a carriage applicable to an embodiment;

FIG. 3B is a schematic front view of the carriage applicable to an embodiment;

FIG. 4 is a block diagram of a control unit applicable to an embodiment;

FIG. 5 is a flowchart of a printing operation applicable to an embodiment;

FIG. 6 is a diagram showing an example of a subroutine of S502;

FIG. 7 is a diagram showing an example of the subroutine of S502;

FIG. 8 is a diagram explaining the contents of S700 applicable to an embodiment;

FIG. 9 is a diagram explaining an effect that can be obtained by limiting an ejection port to use;

FIG. 10 is a diagram explaining the amount of conveyance applicable to an embodiment;

FIG. 11A is a diagram showing a state where a second sensor detects the position of an end portion of a print medium in an embodiment;

FIG. 11B is a diagram showing a state where the print medium is conveyed by the amount of conveyance after the end of the print scanning illustrated in FIG. 11A;

FIG. 11C is a diagram showing a state where a first sensor detects the position of an end portion of a print medium;

FIG. 12A is a diagram for explaining multipass printing without any intervening conveyance operation;

FIG. 12B is a diagram for explaining multipass printing without any intervening conveyance operation;

FIG. 12C is a diagram for explaining multipass printing without any intervening conveyance operation;

FIG. 12D is a diagram for explaining multipass printing without any intervening conveyance operation;

FIG. 12E is a diagram for explaining multipass printing without any intervening conveyance operation;

FIG. 13A is a diagram explaining multipass printing applicable to an embodiment;

FIG. 13B is a diagram explaining multipass printing applicable to an embodiment;

FIG. 13C is a diagram explaining multipass printing applicable to an embodiment;

FIG. 13D is a diagram illustrating multipass printing applicable to an embodiment;

FIG. 13E is a diagram illustrating multipass printing applicable to an embodiment;

FIG. 14 is a flowchart of a printing operation applicable to an embodiment;

FIG. 15A is a diagram showing the state of S1402;

FIG. 15B is a diagram showing the state of S1403;

FIG. 15C is a diagram showing the state of S1407; and

FIG. 15D is a diagram showing the state of S1408.

### DESCRIPTION OF THE EMBODIMENTS

A technique of the present disclosure will be described below with reference to the attached drawings. Incidentally, the following embodiments do not limit the invention of the claims. Although a plurality of features are described in the embodiments, not all of these features are essential to the invention, and the plurality of features may be combined in any manner. Further, in the attached drawings, the same reference numeral is used for the same or a similar constituent, and overlapping descriptions will be omitted.

### First Embodiment

### Printing Apparatus 1

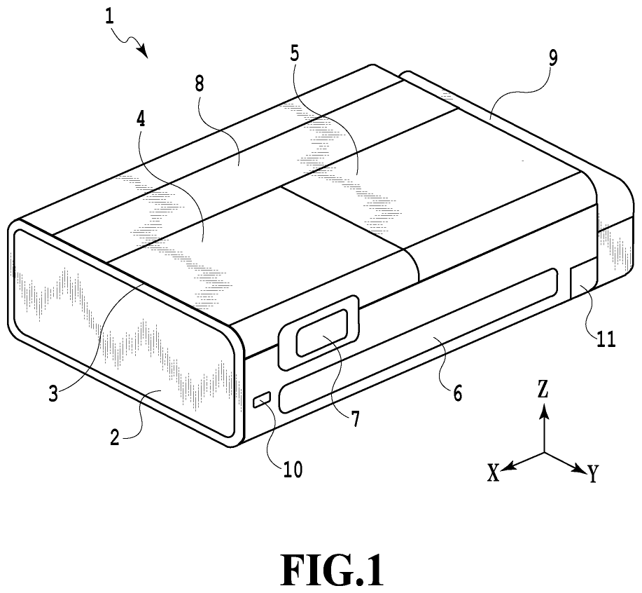

FIG. 1 is a perspective view of the appearance of a printing apparatus 1 applicable to the present embodiment, as viewed from the upper front.

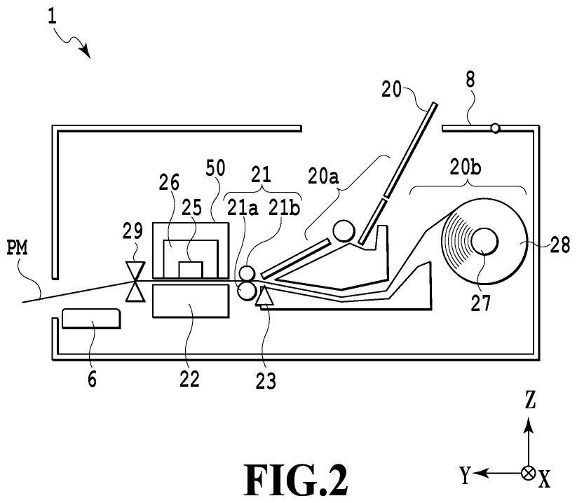

As shown in FIG. 1, the printing apparatus 1 of the present embodiment is an inkjet printing apparatus that ejects ink as liquid to perform printing on a print medium PM. However, the technique of the present disclosure is also applicable to various printing apparatuses other than the inkjet printing apparatus. In FIG. 1, arrows X and Y indicate horizontal directions intersecting with (orthogonal to in the present embodiment) each other on a plane. An arrow Z indicates an up-down direction (gravity direction). An X direction is the width direction (left-right direction) of the printing apparatus 1 and the print medium PM (see FIG. 2). A Y direction is the depth direction of the printing apparatus 1 and a conveyance direction in which the print medium PM is conveyed.

Incidentally, “printing” includes not only the formation of meaningful information such as characters and figures, but also the formation of images, patterns, and the like on the print medium PM irrespective of whether the images, patterns, and the like are meaningful or meaningless, or the processing of a medium, widely. It does not matter whether “printing” is such that elicitation is made such that humans can have a visual perception.

The printing apparatus 1 has a flat rectangular parallelepiped shape as a whole. The printing apparatus 1 includes an apparatus body 2 and a body cover portion 3 including a plurality of covers. The body cover portion 3 is provided so as to cover the apparatus body 2. The body cover portion 3 constitutes a top portion of the printing apparatus 1. The body cover portion 3 is provided with a sheet feed cover 8 for setting the print medium PM, an access cover 5 for performing maintenance work inside the apparatus, and a tank access cover 9 that covers a portion for supplying a tank in the apparatus with ink. The body cover portion 3 is also provided with a scanner unit 4 for reading an image on a document. It is also possible to perform maintenance work inside the apparatus by moving the entire scanner unit 4 to open and close in the same manner as the access cover 5. A front portion of the printing apparatus 1 is provided with a discharge unit 6 that discharges the printed print medium PM. The front portion of the printing apparatus 1 is provided with an operation unit 7 that receives an operation by the operator. The operation unit 7 includes a display unit in a touch panel form. The display unit not only receives an input operation by an operator but also displays information to an operator. The front portion of the printing apparatus 1 is provided with a notification unit 10. The notification unit 10 can make a notification by sound in response to the operation of each unit. The front portion of the printing apparatus 1 is provided with a waste liquid tank unit 11 for inserting a waste liquid tank.

FIG. 2 is an explanatory diagram explaining an internal mechanism of the printing apparatus 1.

As shown in FIG. 2, the printing apparatus 1 includes a conveyance unit 21, a conveyance sensor 23, a feeding unit 20, a print head 26, and a cutter unit 29. The printing apparatus 1 is an apparatus configured to be able to perform printing on the print medium PM. The print medium PM is stored in the feeding unit 20.

The feeding unit 20 is configured to be able to accommodate a target (hereinafter referred to as printing target) to be selected as the print medium PM. In the present embodiment, a cut sheet of a size that conforms to a predetermined standard and a roll sheet 28 obtained by winding a long sheet into a roll shape are used as printing targets. The feeding unit 20 of the present embodiment includes a loading unit 20a configured to be able to load a plurality of cut sheets, and a mounting unit 20b that rotatably mounts the roll sheet 28 in a position different from the loading unit 20a.

The loading unit 20a is arranged downstream of the mounting unit 20b in the conveyance direction (Y direction). An example of the predetermined standard is the Japanese Industrial Standards (JIS). A printing operation on the roll sheet 28 supplied from the mounting unit 20b will be described below.

The mounting unit 20b includes a holding unit that holds the roll sheet 28 obtained by winding a continuous sheet into a roll shape and a drive unit (not shown) that drives the sheet held in the holding unit to rotate. The mounting unit 20b supplies the roll sheet 28 in a direction in which the roll sheet 28 is fed (Y direction) and a direction in which the roll sheet 28 is wound back (−Y direction) by rotating the roll sheet 28 held in the holding unit. A spool member 27 is inserted into the paper tube of the roll sheet 28 and is axially supported by the holding unit of the feeding unit 20. The feeding unit 20 rotates the roll sheet 28 by rotating the spool member 27 with a motor (not shown).

The conveyance unit 21 is a conveyance roller for conveying the print medium PM. The conveyance roller of the present embodiment includes a pair of a drive roller 21a and a driven roller 21b. The conveyance unit 21 includes a drive mechanism (not shown) and drives the drive roller to rotate. The driven roller is pressure-contacted with the drive roller and driven to rotate. Accordingly, the print medium PM is sandwiched between the drive roller and the driven roller and conveyed on a platen 22. For example, a gear mechanism using a motor as a drive source can be used as the drive mechanism of the conveyance unit 21. The rotation amount of the conveyance unit 21 is detected by a sensor (not shown) (e.g., an encoder) to control the amount of conveyance of the print medium PM.

Hereinafter, a portion upstream of the conveyance unit 21 existing on a conveyance path for conveying the print medium PM will be referred to as “upstream side.” On the other hand, a portion downstream of the conveyance unit 21 will be referred to as “downstream side.”

As described above, the conveyance direction in which the print medium PM is conveyed is the Y direction. The Y direction (conveyance direction) is also referred to as sub-scanning direction. The X direction is a direction orthogonal to the conveyance direction of the print medium PM. The X direction is referred to as main scanning direction or sheet width direction. The roll sheet 28 and the conveyance unit 21 are arranged so that the axial directions of the two are parallel to the main scanning direction (X direction).

In the conveyance path for the print medium PM, the conveyance sensor 23 is arranged upstream of the conveyance unit 21. An example of the conveyance sensor 23 is an optical sensor for determining whether the roll sheet 28 has been properly conveyed to the conveyance unit 21.

The print head 26 is arranged downstream of the conveyance unit 21. The print head 26 can perform printing on the print medium PM conveyed by the conveyance unit 21.

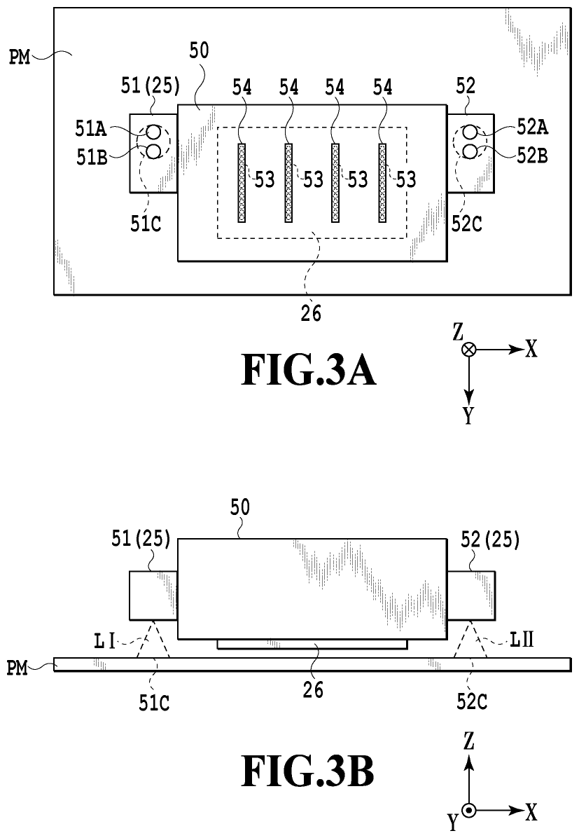

The print head 26 of the present embodiment includes a plurality of ejection ports 53 (see FIGS. 3A and 3B) for ejecting ink. The print head 26 is detachably mounted on the carriage 50. An ink supply tube for supplying the print head 26 with ink is mounted on the carriage 50. The carriage 50 can be reciprocally moved in the X direction by a drive mechanism (not shown). As the drive mechanism for the carriage 50, for example, a belt driving mechanism using a motor as a drive source can be used. The position of the carriage 50 is detected by an encoder (not shown) to control the movement of the carriage 50.

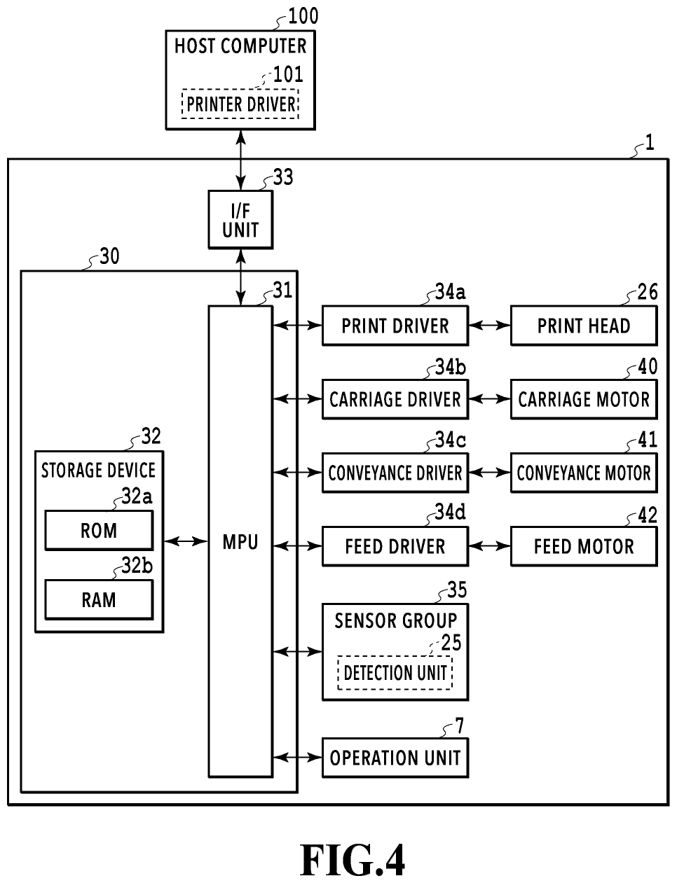

A detection unit 25 (see FIG. 4) can detect the presence or absence of an image printed on the print medium PM, the position of an edge of the print medium PM, the thickness of the print medium PM, and the like. The detection unit 25 may be configured to be able to detect the thickness of the roll sheet 28.

The detection unit 25 is mounted on the carriage 50. The detection unit 25 moves in the X direction together with the carriage 50. The position of the carriage 50 relative to the print medium PM can be obtained based on the position of the carriage 50 obtained by using a result of detection by the detection unit 25 and the amount of conveyance of the print medium PM by the conveyance unit 21.

The cutter unit 29 cuts the print medium PM in the X direction. The cutter unit 29 can be reciprocally moved in the X direction by a cutter motor (not shown). The cutter unit 29 includes a cutter. The cutter unit 29 may also include a pressure sensor (not shown) that detects pressure on the cutter.

### Carriage 50

FIG. 3A is a schematic plan view of the carriage 50 applicable to the present embodiment. FIG. 3B is a schematic front view of the carriage 50 applicable to the present embodiment. A configuration of the carriage 50 will be described below with reference to FIGS. 3A and 3B.

As shown in FIGS. 3A and 3B, the print head 26 and the detection unit 25 are mounted on the carriage 50. An ejection port array 54 formed of the plurality of ejection ports 53 for ejecting liquid is formed on the ejection port surface of the print head 26. The detection unit 25 includes a first sensor 51 provided on one end side in the main scanning direction and a second sensor 52 provided on the other end side in the main scanning direction.

The first sensor 51 includes a first light emitting element 51A that emits first light LI and a first light receiving element 51B that receives reflected light of the first light LI. In the figures, a first light receiving range 51C indicates a range in which the first light LI irradiated from the first light emitting element 51A is received on the print medium PM.

The second sensor 52 includes a second light emitting element 52A that emits second light LII and a second light receiving element 52B that receives reflected light of the second light LII. In the figures, a second light receiving range 52C indicates a range in which the second light LII irradiated from the second light emitting element 52A is received on the print medium PM.

In the present embodiment, the ejection port array 54, the first sensor 51, and the second sensor 52 are arranged so as to overlap in the sub-scanning direction (Y direction), which makes it possible to downsize the carriage 50 in the sub-scanning direction as compared to a configuration in which the ejection port array 54, the first sensor 51, and the second sensor 52 are arranged so as not to overlap in the sub-scanning direction.

For example, in the case of detecting the position of a tip of the print medium PM in the length direction (Y direction), while the carriage 50 is stopped immediately above the conveyance path for the print medium PM, the print medium PM is conveyed in the Y direction, and the tip is caused to pass the detection unit 25 once. The print medium PM is then fed back to the upstream side. Due to a difference in reflection coefficient between the platen 22 and the print medium PM, the value of light received by the first light receiving element 51B varies in a case where the tip of the print medium PM passes through. The position of the tip of the print medium PM can be detected from a result of detection by the encoder that detects the amount of rotation of the conveyance unit 21 in this case. Similarly, the position of an image printed on the print medium PM can also be detected from the detection result of the amount of rotation of the conveyance unit 21 at a point where the result of light reception of the first light receiving element 51B changes and from the detection result of the position of the carriage 50.

Incidentally, it is assumed above that the first sensor 51 is used, but the second sensor 52 may be used to perform detection similar to that using the first sensor 51.

In the present embodiment, a relatively inexpensive detection unit 25 is used such that the first light receiving range 51C and the second light receiving range 52C are approximately 5.0 mm.

### Control Unit 30

FIG. 4 is a block diagram of a control unit 30 of the printing apparatus 1 applicable to the present embodiment.

As shown in FIG. 4, the printing apparatus 1 includes the control unit 30. The control unit 30 includes an MPU 31 and a storage device 32. The MPU 31 is a processor that controls each operation of the printing apparatus 1 and data processing. The MPU 31 executes a program stored in the storage device 32 to perform overall control of the printing apparatus 1.

The storage device 32 includes a ROM 32a and a RAM 32b. For example, the ROM 32a stores various kinds of data required for processing, such as a program executed by the MPU 31 and data received from a host computer 100.

The MPU 31 controls the print head 26 via a print driver 34a. The MPU 31 controls a carriage motor 40 via a carriage driver 34b. The MPU 31 controls a conveyance motor 41 via a conveyance driver 34c. The MPU 31 controls a feed motor 42 via a feed driver 34d.

The MPU 31 obtains detection results from a group of various sensors 35 provided in the printing apparatus 1 to perform a control operation. The sensor group 35 includes the detection unit 25. The MPU 31 performs display control of the display unit of the operation unit 7 and receives an operation on the operation unit 7 by an operator.

Examples of the host computer 100 include a personal computer, a mobile terminal, and the like used by an operator. Examples of the mobile terminal include a smartphone, a tablet terminal, and the like. A printer driver 101 that performs communication between the host computer 100 and the printing apparatus 1 is installed on the host computer 100.

The printing apparatus 1 includes an interface unit 33. Communication between the host computer 100 and the MPU 31 is executed via the interface unit 33. For example, in a case where the host computer 100 receives an input from an operator to execute a printing operation, the printer driver 101 coordinates image data to be printed with settings for printing (information such as the quality of a printed image) to instruct the printing apparatus 1 to execute the printing operation.

### Printing Operation

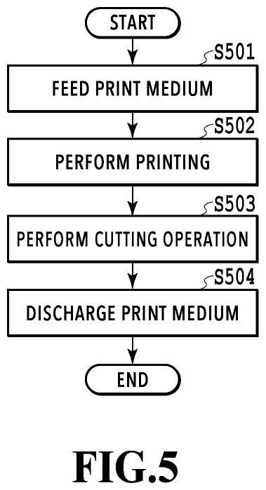

FIG. 5 is a flowchart of a printing operation applicable to the present embodiment. FIG. 5 illustrates a case where the roll sheet 28 is used as the print medium PM (see FIG. 2, etc.). “S” in FIG. 5 means a step. A process shown in the present flowchart is performed by the MPU 31 rasterizing a program code stored in the ROM 32a into the RAM 32b (see FIG. 4) and executing the program code. The same applies to flowcharts in the other figures.

The process shown in the present flowchart is triggered to start by the MPU 31 receiving an instruction to execute a printing operation. For example, in a case where an operator inputs an instruction to execute a printing operation to the host computer 100, the MPU 31 receives the execution instruction.

In S501, the MPU 31 controls the feed motor 42 (see FIG. 4) to feed the print medium PM.

In S502, the MPU 31 drives the print head 26, the carriage motor 40, and the conveyance motor 41 to perform printing. In S502, the conveyance of the print medium PM by the conveyance unit 21 and ink ejection using the print head 26 accompanied by carriage movement are alternately repeated. The conveyance of the print medium PM and the ink ejection are repeated until the end of printing.

In S503, the MPU 31 controls the conveyance motor 41 and the cutter unit 29 to perform a cutting operation to cut the print medium PM.

In S504, the MPU 31 discharges the cut print medium PM.

The above is an explanation of the printing operation in the present embodiment.

In the present embodiment, the printing apparatus 1 can perform printing (margined printing) in which a sufficient margin can be ensured in the main scanning direction and printing (micro-margin printing) in which a margin in the main scanning direction is smaller than that in margined printing.

The printing apparatus 1 can also perform printing (marginless printing) in which margins on the print medium PM are eliminated by discarding liquid to the outside of the print medium PM during a printing operation. As compared to marginless printing, micro-margin printing can reduce the amount of margins in the width direction (X direction) of the print medium PM to the extent that the margins are visually less noticeable without discarding liquid. In the present embodiment, an operator can freely select whether to perform margined printing, marginless printing, or micro-margin printing as printing in S502.

### Margined Printing

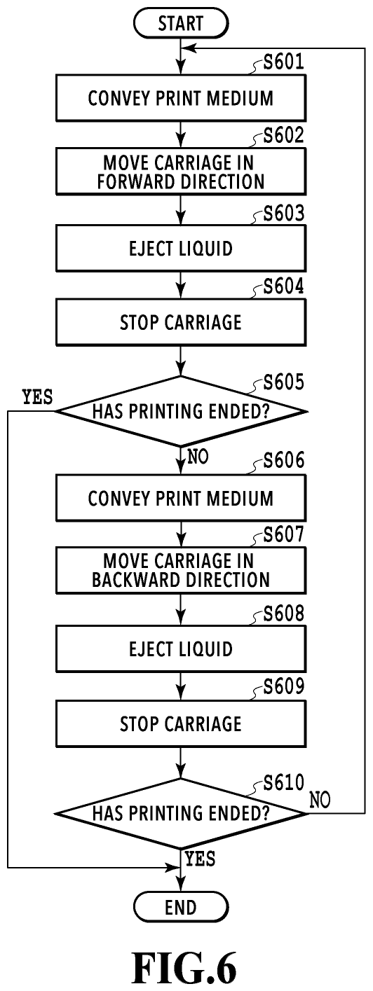

FIG. 6 shows an example of a subroutine of S502 applicable to the present embodiment. FIG. 6 illustrates a case where margined printing is performed.

In S601, the MPU 31 drives the conveyance motor 41 to convey the print medium PM to a designated position.

In S602, the MPU 31 drives the carriage motor 40 to start moving the carriage 50 in a forward direction.

In S603, the MPU 31 controls the print head 26 to eject liquid from a predetermined one of the ejection ports 53 in the print head 26 while the carriage 50 is moving in the forward direction. In margined printing, the ejection port 53 formed in an area that overlaps an inspection area for the first sensor 51 can also be used among the plurality of ejection ports 53 forming one ejection port array. This is because in margined printing, since there is a margin at an end portion of a print medium, even in a case where there is an overlapping area, irradiated light does not hit a printed image, and an effect on the accuracy of detection of the position of the end portion of the print medium is small.

In S604, the MPU 31 stops driving the carriage motor 40 and stops the carriage 50.

In S605, the MPU 31 uses a known method to determine whether margined printing has ended.

In a case where margined printing has ended (YES in S605), the MPU 31 ends the present subroutine and performs the processing in S503 (see FIG. 5). On the other hand, in a case where margined printing has not ended (NO in S605), the MPU 31 performs processing in S606.

In S606, the MPU 31 drives the conveyance motor 41 to convey the print medium PM to a designated position.

In S607, the MPU 31 drives the carriage motor 40 to start moving the carriage 50 in a backward direction.

In S608, the MPU 31 controls the print head 26 to eject liquid from a predetermined one of the ejection ports 53 in the print head 26 while the carriage 50 is moving in the backward direction. In margined printing, the ejection port 53 formed in an area that overlaps an inspection area for the first sensor 51 can also be used among the plurality of ejection ports 53 forming one ejection port array. This is because in margined printing, since there is a margin at an end portion of a print medium, even in a case where there is an overlapping area, irradiated light does not hit a printed image, and an effect on the accuracy of detection of the position of the end portion of the print medium is small.

In S609, the MPU 31 stops driving the carriage motor 40 and stops the carriage 50.

In S610, the MPU 31 uses a known method to determine whether printing has ended (whether there is any data to be printed in the next scanning). In a case where printing has ended (YES in S610), the MPU 31 ends the present subroutine and performs the processing in S503 (see FIG. 5). On the other hand, in a case where printing has not ended (NO in S605), the MPU 31 performs the processing in S601 again.

The above is an explanation of a case where margined printing is performed in S502. Next, a case where micro-margin printing is performed in S502 will be described.

### Micro-Margin Printing

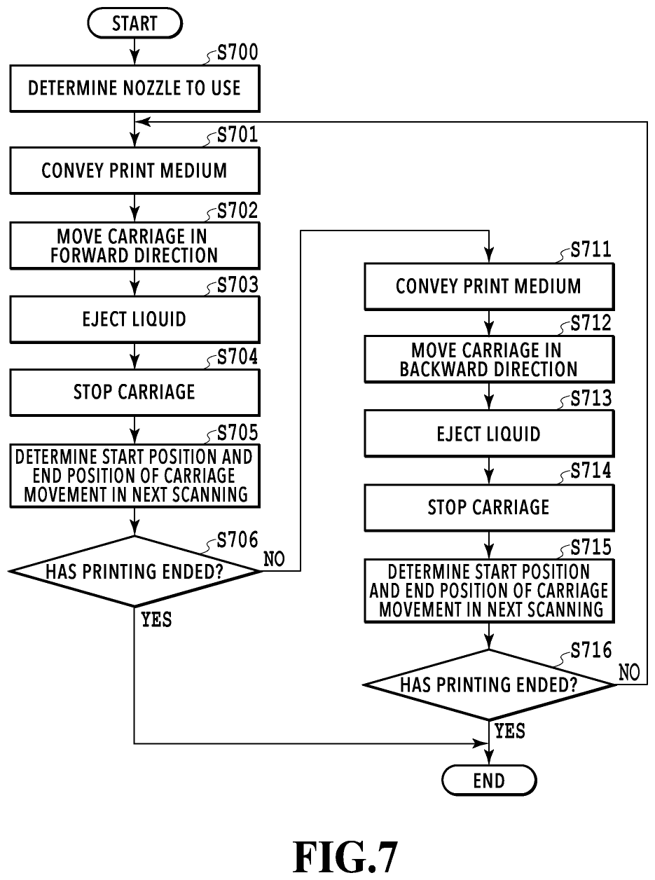

FIG. 7 shows an example of the subroutine of S502 applicable to the present embodiment. FIG. 7 illustrates a case where micro-margin printing is performed.

In S700, the MPU 31 determines the ejection port 53 to use from among the plurality of ejection ports 53 constituting one of the ejection port arrays 54.

In S701, the MPU 31 drives the conveyance motor 41 to convey the print medium PM to a designated position.

In S702, the MPU 31 drives the carriage motor 40 to start moving the carriage 50 in the forward direction (forward scanning).

In S703, the MPU 31 controls the print head 26 to eject liquid from the ejection port 53 determined in S700 while the carriage 50 is moving in the forward direction. Of the plurality of ejection ports 53 forming one ejection port array, the ejection port 53 formed in an area overlapping an inspection area for the first sensor 51 is not used. Incidentally, in an area of the print medium through which the ejection port 53 not used in the current scanning passes, an image is printed in the next scanning after the conveyance of the print medium.

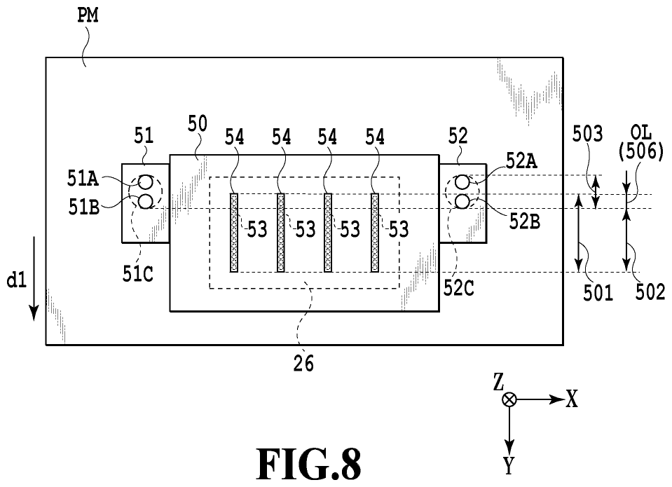

During the print scanning, the MPU 31 monitors a result of detection by the first sensor 51 and obtains the position of one end portion of the print medium PM in the width direction (X direction) (for example, the left end portion of the print medium PM shown in FIG. 8).

In S704, the MPU 31 stops driving the carriage motor 40 and stops the carriage 50.

In S705, the MPU 31 determines the start print position and print end position of the print head 26 in the next scanning based on the position of the end portion of the print medium PM obtained in S703. Specifically, in backward scanning subsequently performed after the immediately preceding forward scanning, the MPU 31 determines the start and end timings of an ejection operation with the print head 26 in association with the position of the carriage 50 managed by the encoder.

In S706, the MPU 31 uses a known method to determine whether printing has ended (whether there is any data to be printed in the next scanning). In a case where printing has ended (YES in S706), the MPU 31 ends the present subroutine and performs the processing in S503 (see FIG. 5). On the other hand, in a case where printing has not ended (NO in S706), the MPU 31 performs processing in S711.

In S711, the MPU 31 drives the conveyance motor 41 to convey the print medium PM to a designated position.

In S712, the MPU 31 drives the carriage motor 40 to start moving the carriage 50 in the backward direction (backward scanning).

In S713, the MPU 31 controls the print head 26 to eject liquid from the ejection port 53 determined in S700 while the carriage 50 is moving in the backward direction. Of the plurality of ejection ports 53 forming one ejection port array, the ejection port 53 formed in an area overlapping an inspection area for the second sensor 52 is not used. Incidentally, in an area of the print medium through which the ejection port 53 not used in the current scanning passes, an image is printed in the next scanning after the conveyance of the print medium. During the print scanning, the MPU 31 monitors a result of detection by the second sensor 52 and obtains the position of the other end portion of the print medium PM in the width direction (for example, the right end portion of the print medium PM shown in FIG. 8).

In S714, the MPU 31 stops driving the carriage motor 40 and stops the carriage 50.

In S715, the MPU 31 determines the print start position and print end position of the print head 26 in the next scanning based on the position of the end portion of the print medium PM obtained in S713. Specifically, in the forward scanning subsequently performed after the immediately preceding backward scanning, the MPU 31 determines the start and end timings of an ejection operation by the print head 26 in association with the position of the carriage 50 managed by the encoder.

In S716, the MPU 31 uses a known method to determine whether printing has ended (whether there is any data to be printed in the next scanning). In a case where printing has ended (YES in S716), the MPU 31 ends the present subroutine and performs the processing in S503 (see FIG. 5). On the other hand, in a case where printing has not ended (NO in S716), the MPU 31 performs the processing in S701 again.

The above is an explanation of the subroutine of S502 in a case where micro-margin printing is performed. Next, the step (S700) of determining the ejection port 53 to be used in micro-margin printing will be described with reference to the drawings.

FIG. 8 is a diagram explaining the contents of S700 in the present embodiment.

As shown in FIG. 8, a portion of the plurality of ejection ports 53 constituting one of the ejection port arrays 54 overlaps a portion of the first sensor 51 in the conveyance direction (Y direction). Hereinafter, the amount of overlap will be referred to as amount of overlap OL. Incidentally, although FIG. 8 shows an example in which the ejection ports 53 overlap the first light receiving element 51B, the ejection ports 53 may also overlap the first light emitting element 51A depending on the configuration of the first sensor 51. The technique of the present disclosure can be applied even to such a configuration.

Further, a portion of the plurality of ejection ports 53 constituting one of the ejection port arrays 54 overlaps a portion of the second sensor 52 in the conveyance direction (Y direction). Incidentally, although FIG. 8 shows an example in which the ejection ports 53 overlap the second light receiving element 52B, the ejection ports 53 may also overlap the second light emitting element 52A depending on the configuration of the second sensor 52. The technique of the present disclosure can be applied even to such a configuration.

According to the configuration, the entire apparatus can be downsized in the conveyance direction as compared to a configuration in which the first sensor 51 and the second sensor 52 do not overlap one or more ejection ports 53 in the conveyance direction.

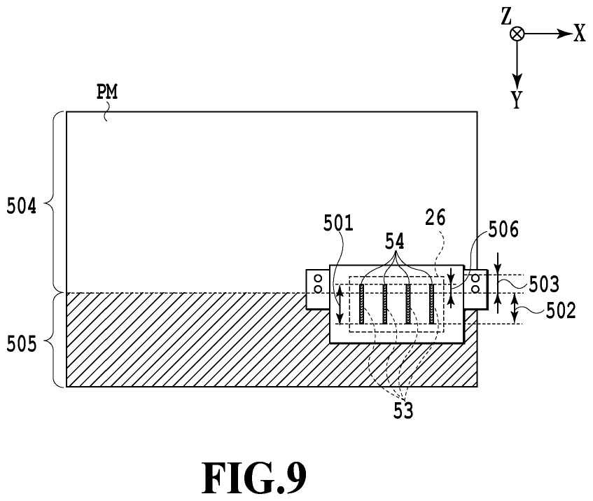

FIG. 9 is a diagram explaining an effect that can be obtained by limiting the ejection port 53 to be used.

As shown in FIG. 9, a print area 505 where printing has ended by ejecting liquid from the print head 26 is formed on the print medium PM. In the conveyance direction (Y direction), an unprinted area 504 where printing has not yet been performed exists upstream of the print area 505.

In a case where micro-margin printing is performed, the amount of margins from an end portion of the print area 505 to an end portion of the print medium PM in the main scanning direction is controlled to be equal to or less than a predetermined value such that no margin is visible. For example, the amount of margins in the X direction from the end portion of the print area 505 to the end portion of the print medium PM is controlled to be equal to or less than 1.5 mm. The amount of margins may also be 1.0 mm or less, or 0.5 mm or less.

As described above, in the present embodiment, in order to downsize the print head 26, the first sensor 51 and the second sensor 52 are arranged to overlap in the conveyance direction with respect to the ejection port arrays 54. In this configuration, in a case where an attempt is made to detect an end portion of the print medium PM while liquid is being ejected from all the ejection ports 53 constituting one of the ejection port arrays 54, light irradiated from the detection unit 25 (see FIG. 2, etc.) may hit the print area 505. That is, there is a possibility that an area that is not blank on the print medium PM may be irradiated with light.

For example, in a plan view of the print head 26 and the print medium PM located below the print head 26, it is assumed that the print head 26 performs print scanning in the X direction to print a black image up to the other end portion of the print medium PM (the right end portion in FIG. 9). In this case, in a case where the second light receiving range 52C (see FIG. 3B) overlaps the black image, the second light LII is absorbed into the black image. Thus, the amount of reflected light of the second light LII received by the second light receiving element 52B (see FIG. 3B) is reduced, which makes it difficult to properly detect an end portion of the print medium PM.

Thus, in performing micro-margin printing, the present embodiment uses only the ejection port 53 formed inside a non-overlap area 502 of an ejection range 501 for the print head 26 that does not overlap a detection range 503 of the detection unit 25. The discharge port 53 formed inside an overlap area 506 that overlaps the detection range 503 of the ejection range 501 is not used. In detecting the position of an end portion in the width direction (X direction) of the print medium PM, this configuration makes it possible to detect the position of the end portion in the width direction in the unprinted region 504 where printing has not yet been performed on the print medium PM.

As described above, in micro-margin printing of the present embodiment, in detecting the position of an end portion in the width direction of the print medium PM, the unprinted area 504 (e.g., a white flat surface) is irradiated with light. Thus, in the present embodiment, as compared to a case where the print area 505 (e.g., a portion where black ink has been ejected) is irradiated with light, the irradiated light is less likely to be absorbed or diffused but is strongly reflected linearly.

Accordingly, the printing apparatus of the present disclosure herein makes it possible to detect the position of an end portion of the print medium PM with high accuracy, which also makes it possible to perform printing on the print medium PM with high accuracy.

### Second Embodiment

A second embodiment for the technique of the present disclosure will be described below with reference to the drawings. The present embodiment is directed to providing a printing apparatus capable of detecting the position of an end portion of the print medium PM with high accuracy. In the following description, the same reference numeral is used for a constituent similar to or corresponding to that in the first embodiment, the description thereof will be omitted, and differences will be mainly described.

In the present embodiment, it is assumed that micro-margin printing is performed by multipass printing. Here, the multipass printing is a printing method in which an image is completed in stages in a unit area of a print medium through print scanning performed multiple times with the print head 26.

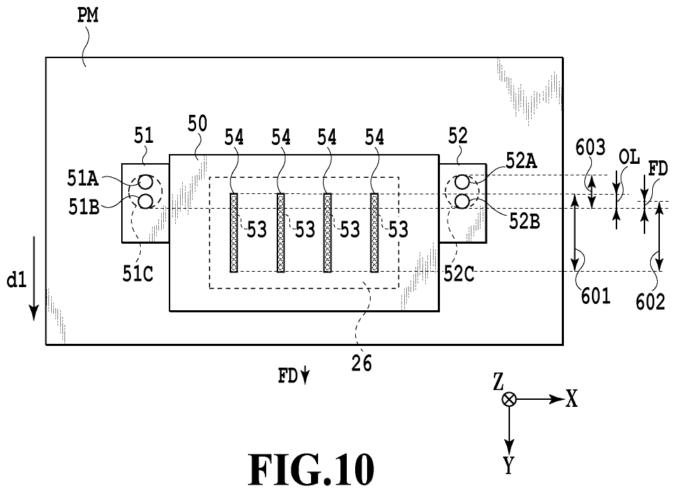

FIG. 10 is a diagram explaining the amount of conveyance applicable to the present embodiment.

As shown in FIG. 10, the amount of conveyance FD per one time is set to be smaller than the amount of overlap OL. In a printing operation of the present embodiment, the ejection port 53 formed inside an area 602 obtained by adding a region corresponding to the amount of conveyance FD to the non-overlap area 502 (see FIG. 9) of an ejection range 601 where liquid is ejected is used. That is, in the present embodiment, even in a case where the ejection port 53 is formed inside the overlap area 506, the ejection port 53 formed inside the region corresponding to the amount of conveyance FD is allowed to be used.

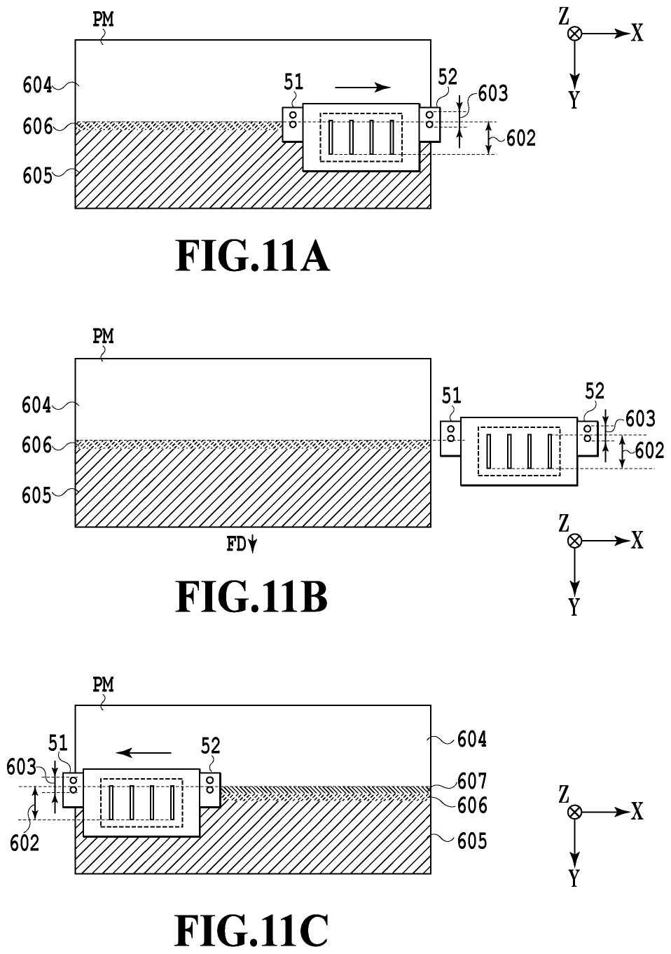

FIG. 11A is a diagram showing a state where the second sensor 52 detects the position of one end portion of the print medium PM in the present embodiment.

As shown in FIG. 11A, while printing is being performed by the carriage 50 performing backward scanning, the second sensor 52 detects the position of the other end portion of the print medium PM (the right end portion in FIG. 11A). Here, a print area 605 indicates an area to which ink has been applied through print scanning up to the previous print scanning. On the other hand, a print area 606 indicates an area to which ink is applied for the first time through the current print scanning. In a case where the second sensor 52 detects an end portion, the end portion (the other end portion) is located upstream of the print area 605.

FIG. 11B shows a state where the print medium PM is conveyed by the amount of conveyance FD after the end of the print scanning illustrated in FIG. 11A.

FIG. 11C is a diagram showing a state where the first sensor 51 detects the position of an end portion of the print medium PM.

As shown in FIG. 11C, while printing is being performed by the carriage 50 performing forward scanning, the first sensor 51 detects the position of one end portion of the print medium PM (the left end portion in FIG. 11C). Here, the print area 605 indicates an area to which ink has been applied through print scanning up to the print scanning two times before. The print area 606 indicates an area to which ink is applied for the first time through the previous print scanning. A print area 607 indicates an area to which ink is applied for the first time through the current print scanning. In a case where the first sensor 51 detects an end portion, the end portion is located further upstream of the print area 607.

As described above, in the present embodiment, in micro-margin printing employing multipass printing, the amount of conveyance FD of the print medium PM is set to be smaller than the amount of overlap OL. Thus, in both forward scanning and backward scanning, in detecting the position of an end portion of the print medium PM, the first light receiving range 51C and the second light receiving range 52C (see FIG. 3A, etc.) for detecting the end portion can be reliably contained within the unprinted area 604.

Therefore, the printing apparatus of the present embodiment makes it possible to detect the position of an end portion of the print medium PM with high accuracy in micro-margin printing employing multipass printing.

### Third Embodiment

A third embodiment for the technique of the present disclosure will be described below with reference to the drawings. The present embodiment is directed to providing a printing apparatus capable of detecting the position of an end portion of the print medium PM with high accuracy. In the following description, the same reference numeral is used for a constituent similar to or corresponding to that in the first and second embodiments, the description thereof will be omitted, and differences will be mainly described. In the present embodiment, micro-margin printing is performed by performing multipass printing without any intervening conveyance operation.

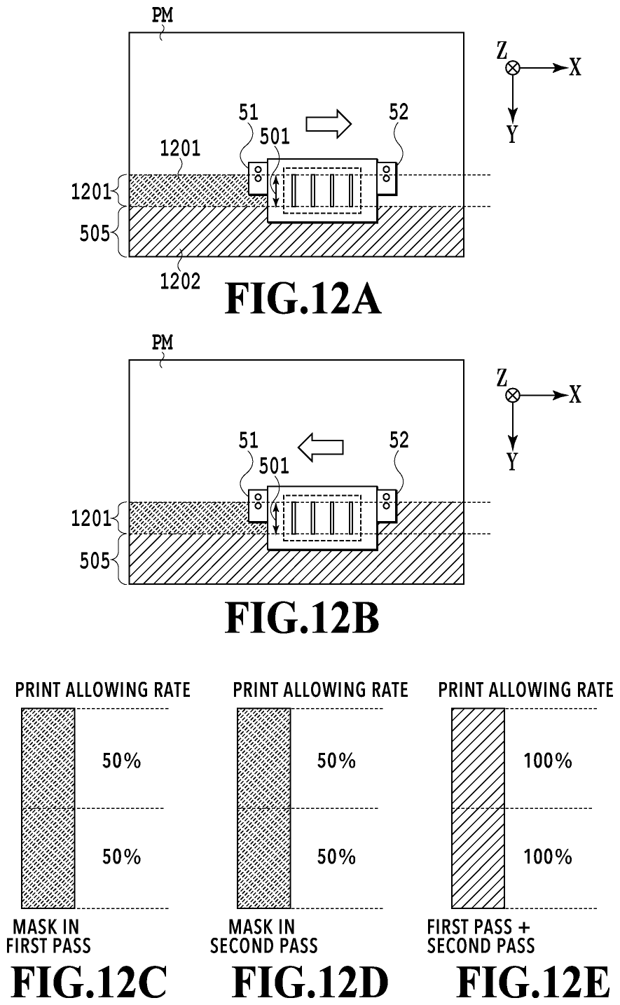

FIGS. 12A to 12E are diagrams for explaining multipass printing without any intervening conveyance operation, with two-pass multipass printing being taken as an example.

In two-pass multipass printing, first printing is performed on a unit area 1201 as shown in FIG. 12A, and second printing is then performed on the same unit area 1201 as shown in FIG. 12B. In such multipass printing, processing is performed to thin out image data sent from outside (e.g., the host computer 100 [see FIG. 4]) based on a preset print mask. A print mask is a mask pattern that defines pixels that allow printing with dots and pixels that do not allow printing with dots in one scan.

FIG. 12C shows an example of a mask pattern used in first print scanning for each unit area. The print allowing rate, which is the ratio of pixels that allow printing, is 50%. FIG. 12D shows an example of a mask pattern used in second print scanning for each unit area. The print allowing rate, which is the ratio of pixels that allow printing, is 50%. The mask patterns in FIG. 12C and FIG. 12D complement each other, and by overlapping these mask patterns, a mask pattern with a print allowing rate of 100% as shown in FIG. 12E is obtained.

In the first print scanning on the unit area 1201 using the mask pattern in FIG. 12C, the second sensor 52 detects the position of the other end portion of the print medium PM (the right end portion in the example in FIG. 12A) as shown in FIG. 12A. In the second print scanning on the same unit area 1201 using the mask pattern in FIG. 12D, the first sensor 51 detects the position of one end portion of the print medium PM (the left end portion in the example in FIG. 12B) as shown in FIG. 12B.

However, in detecting the position of the left end portion of the print medium PM in the second print scanning, printing has been performed in the vicinity of the end portion in the first print scanning. That is, ink has already been applied to the first light receiving range 51C (see FIG. 8), which reduces the accuracy of the detection. That is, in the method according to the present example, in detecting the position of an end portion of the print medium PM in the second print scanning for the unit area, since an image has been formed in the first scanning, the accuracy of the detection is reduced. Thus, the present embodiment is characterized by the contents of a mask pattern to be used.

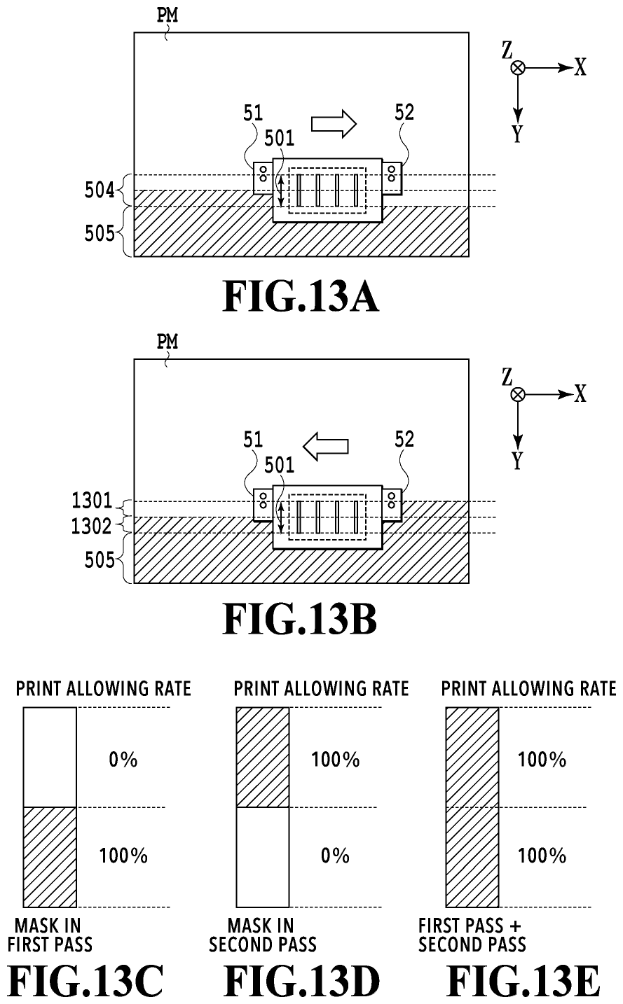

FIGS. 13A to 13E are diagrams explaining multipass printing applicable to the present embodiment.

FIG. 13C shows a mask pattern used in the first print scanning for each unit area. In the present embodiment, the ejection range 501 is divided into two, an upstream side 1301 and a downstream side 1302 in the conveyance direction, with the print allowing rate on the upstream side being 0% and the print allowing rate on the downstream side being 100%. FIG. 13D shows a mask pattern used in the second print scanning for each unit area. The print allowing rate on the upstream side is 100% and the print allowing rate on the downstream side is 0%. The mask patterns in FIG. 13C and FIG. 13D complement each other, and by overlapping the mask patterns, a mask pattern with a print allowing rate of 100% as shown in FIG. 13E is obtained.

In the case of using this mask pattern to perform micro-margin printing, in the first print scanning using the mask pattern in FIG. 13C for a unit area, the second sensor 52 detects the position of the other end portion of the print medium PM. That is, in the example in FIG. 13A, the position of the right end portion of the print medium PM is detected. Specifically, the second sensor 52 detects a blank area at the right end portion.

In the case of using the mask pattern in FIG. 13D to perform the second print scanning for the same unit area, as shown in FIG. 13B, the first sensor 51 is used to detect the position of one end portion of the print medium PM (the left end portion in the example in FIG. 13B). At this time, the first sensor 51 detects a blank area at the left end portion.

Thus, using the mask patterns of the present embodiment makes it possible to perform micro-margin printing with high accuracy while accurately detecting the position of an end portion of the print medium PM in multipass printing without any intervening conveyance operation.

### Fourth Embodiment

A fourth embodiment for the technique of the present disclosure will be described below with reference to the drawings. The present embodiment is directed to providing a printing apparatus capable of detecting the position of an end portion of the print medium PM with high accuracy. In the following description, the same reference numeral is used for a constituent similar to or corresponding to that in the first to third embodiments, the description thereof will be omitted, and differences will be mainly described.

In the first embodiment, bidirectional micro-margin printing in which print scanning is performed in both forward and backward paths has been described. On the other hand, in the present embodiment, unidirectional micro-margin printing in which print scanning is performed only in the forward path will be described.

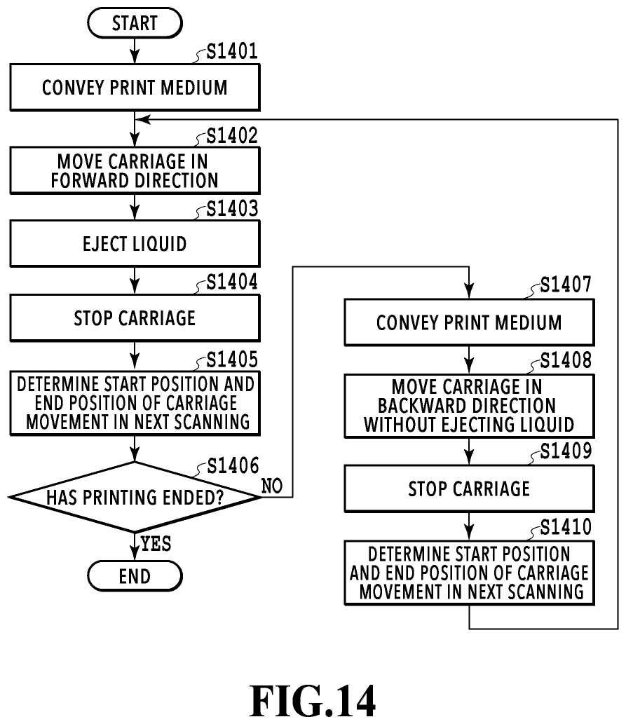

FIG. 14 shows an example of the subroutine of S502 applicable to the present embodiment.

In S1401, the MPU 31 controls the conveyance motor 41 to convey the print medium PM to a predetermined position.

In S1402, the MPU 31 controls the carriage motor 40 to start moving the carriage 50 in the forward direction.

In S1403, while the carriage 50 is moving in the forward direction, the MPU 31 controls the print head 26 to eject liquid from the print head 26. Incidentally, although details will be described later, in the present embodiment, liquid can be ejected from all ejection ports 53 constituting one of the ejection port arrays 54. During print scanning, the MPU 31 monitors a result of detection by the first sensor 51 and obtains the position of the other end portion of the print medium PM.

In S1404, the MPU 31 controls the carriage motor 40 to stop the carriage 50.

In S1405, the MPU 31 updates information on a print area where printing has been performed with the print head 26 (information including a print start position and a print end position) based on the position of the other end portion obtained in S1403.

In S1406, the MPU 31 uses a known method to determine whether printing has ended (whether there is any data to be printed in the next print scanning). In a case where printing has ended, the MPU 31 ends the present subroutine and executes the processing in S503 (see FIG. 5). On the other hand, in a case where printing has not ended, the MPU 31 executes processing in S1407.

In S1407, the MPU 31 conveys the print medium PM by a predetermined amount. The amount of conveyance of the print medium PM in S1407 corresponds to the length of the ejection port array 54 in the conveyance direction. This amount of conveyance is greater than the amount of overlap between the detection range of the detection unit 25 and the print area of the print medium PM in the conveyance direction.

In S1408, the MPU 31 controls the carriage motor 40 to move the carriage 50 in the backward direction without ejecting liquid from the print head 26. During this movement, the MPU 31 monitors a result of detection by the second sensor 52 and obtains the position of an end portion of the print medium PM.

In S1409, the MPU 31 controls the carriage motor 40 to stop the carriage 50.

In S1410, the MPU 31 updates information (information including a print start position and a print end position) on the print area where printing has been performed with the print head 26 based on the position of one end portion obtained in S1408. That is, the start and end positions of a carriage movement in the next backward scanning are determined. After the end of the processing in S1410, the MPU 31 repeats the process from S1402 to S1406.

The above is an explanation of the flowchart in the present embodiment.

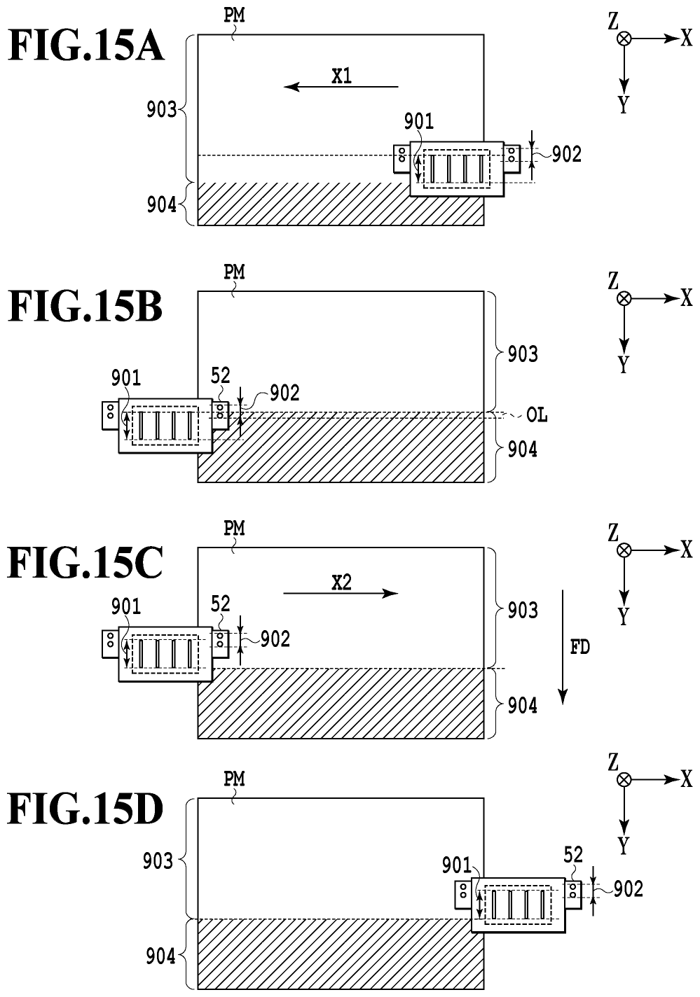

FIGS. 15A to 15D are explanatory diagrams of a printing operation applicable to the present embodiment.

FIG. 15A is a diagram showing the state of S1402.

As shown in FIG. 15A, the print medium PM includes a print area 904 where printing has already been performed and an unprinted area 903 where printing has not yet been performed. The print head 26 includes an ejection range 901 for ejecting liquid. In the present embodiment, an irradiation range in which the detection unit 25 irradiates light is shown as a detection range 902. Incidentally, an X1 direction indicates a forward scanning direction.

FIG. 15B is a diagram showing the state of S1403.

As shown in FIG. 15B, in a case where forward scanning ends, the carriage 50 stops at one end portion of the print medium PM (in FIG. 15B, the left end portion in a plan view of the print medium PM during printing).

FIG. 15C is a diagram showing the state of S1407.

As shown in FIG. 15C, after the forward scanning and before the backward scanning, the print medium PM is conveyed in the conveyance direction (Y direction). The amount of conveyance FD of the print medium PM in this case is equal to or greater than the amount of overlap OL (see FIG. 15B) between the ejection range 901 and the detection range 902. Incidentally, an X2 direction indicates a backward scanning direction.

FIG. 15D is a diagram showing the state of S1408.

As shown in FIG. 15D, in the present embodiment, no printing is performed in backward scanning. That is, in the present embodiment, an idle scan is performed in backward scanning. Thus, in the present embodiment, a new print area 904 is not formed on the print medium PM in backward scanning.

As described above, in the present embodiment, the amount of conveyance FD of the print medium PM is set to be smaller than the amount of overlap OL between the ejection range 901 and the detection range 902. In the backward scanning performed after the conveyance, no printing is performed. Thus, in forward scanning in which the first sensor 51 detects a left end portion or in backward scanning in which the second sensor 52 detects a right end portion, no printing is performed at the end portions of the print medium PM detected by the respective sensors, and the unprinted area 903 is irradiated with the light of each sensor.

Therefore, such a configuration also makes it possible to detect the position of an end portion of the print medium PM with high accuracy.

For example, in a case where the amount of conveyance FD is the same as the length of the ejection range 901 in the conveyance direction, there is no need to restrict the ejection range 901. That is, it is also possible to eject liquid with all ejection ports constituting one of the ejection port arrays 54. Such a configuration makes it easier to control liquid ejection as compared to the case of restricting the ejection range 901.

### OTHER EMBODIMENTS

In the first to fourth embodiments, it is assumed that a roll sheet is used as a print medium. However, a print medium to which the technique of the present disclosure is applicable is not limited to a roll sheet. For example, a cut sheet may also be used as the print medium. Further, the print medium to which the technique of the present disclosure is applicable is not limited to paper as long as the print medium is a medium having end portions whose positions can be detected. For example, cloth, plastic, film, and the like may be used as the print medium.

In the first to fourth embodiments, the position of an end portion of a print medium is detected after first scanning and before second scanning. However, the position of an end portion of a print medium may also be detected while the printing operation is stopped.

In the first to fourth embodiments, there is no difference in performance between the first sensor and the second sensor. However, one of the first sensor and the second sensor may be configured to have higher performance than the other. For example, the first sensor may be configured so that the diameter of the first light receiving range is 1.0 mm or less, and the second sensor may be configured so that the diameter of the second light receiving range is 5.0 mm or more.

In the first to fourth embodiments, it is assumed that micro-margin printing is mainly performed. However, the technique of the present disclosure is also applicable to marginless printing. Even in a case where marginless printing is performed, the amount of liquid to be discarded can be reduced by detecting the position of an end portion of a print medium with high accuracy.

In the third embodiment, it is assumed that two-pass multipass printing is performed. However, the number of passes in multipass printing is not limited to two. Even in a case where while one-pass printing is set to be performed, multipass printing is performed temporarily during the printing operation, the technique of the third embodiment is also applicable. For example, even in a state where one-pass printing is set to be performed, in a case where a high print allowing rate is allowed for a certain scan, multipass printing may be performed only for that scan in order to reduce power supply capacity. In such a case, the technique of the third embodiment may also be applied.

Further, even in a case where the number of divided scans is further increased, such as a case where multipass printing is performed in four or more passes rather than just two passes, the technique of the third embodiment can be applied by first performing printing at an end portion opposite the end portion whose position is to be detected.

In the third embodiment, no print medium is conveyed after the end of a first pass for a unit area and before the start of a second pass. However, in a case where a detection range overlaps a print area, the print medium PM may be conveyed so that the detection range overlaps an unprinted area after the end of the first pass and before the start of the second pass in consideration of the amount of conveyance and the detection range.

The third embodiment shows an example in which the print allowing rate for one of two parts obtained by dividing the unit area divided into two is 100% and the allowing rate for the other is 0%. However, examples of the allowing rate are not limited to this example. In a case where there is no effect on detection, the allowing rate may be set to several percent to several tens of percent instead of 0%. Setting the allowing rate to a value other than zero makes it possible to reduce the effect of an air flow generated in a case where liquid is ejected from an ejection port. As described above, the allowing rate may be set in consideration of a balance between the effect of reducing streaks and unevenness at an end portion in the conveyance direction and the accuracy of detection of the end portion of the print medium PM.

In the fourth embodiment, printing is performed only during forward scanning. However, printing may be performed only during backward scanning. In that case, the first sensor is used to irradiate an unprinted area with light.

The order of the steps in the flowcharts in the first to fourth embodiments may be changed as appropriate. Alternatively, the steps in the flowcharts in the first to fourth embodiments may also be performed simultaneously.

The first to fourth embodiments described above may be combined as appropriate. For example, as in the first embodiment, control may be performed to adjust the amount of conveyance of a print medium after selecting an ejection port to be used and an ejection port not to be used from among a plurality of ejection ports forming one ejection port array. This configuration also makes it possible to detect the position of an end portion by irradiating a blank portion of the print medium with light.

Further, in a situation where multipass printing is performed, an ejection port to be used and an ejection port not to be used may be selected from among a plurality of ejection ports forming one ejection port array to adjust the amount of conveyance of a print medium. This configuration also makes it possible to detect the position of an end portion by irradiating a blank portion of the print medium with light.

Further, there may be a plurality of variations of margined printing. For example, before a printing operation starts, a detection unit may be used to obtain position information on a tip of a print medium (i.e., width information). In this case, it is possible to obtain a shift amount by which the print medium is shifted in the width direction from a normal position and suppress jamming in consideration of the shift amount. Further, even in margined printing, the position of an end portion of the print medium may be detected in both forward and backward scanning. In this case, it is possible to print an image with a more accurate margin width. Further, in margined printing, in a case where printing speed is prioritized over printing accuracy, it is not necessary to detect the position of the end portion of the print medium.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-164374, filed Sep. 20, 2024, which is hereby incorporated by reference herein in its entirety.

According to the printing apparatus of the present disclosure, the position of an end portion of a print medium can be detected with high accuracy.

What is claimed is:

1. A printing apparatus comprising:
a conveyance unit configured to convey a print medium in a conveyance direction;
a carriage configured to perform scanning in a scanning direction intersecting the conveyance direction;
a print head mounted on the carriage and including an ejection port array in which a plurality of ejection ports for ejecting liquid are arranged in the conveyance direction to perform printing by ejecting the liquid from the ejection ports onto the print medium conveyed by the conveyance unit;
a detection unit provided on the carriage and configured to detect a position of an end portion of the print medium; and
a control unit configured to control driving of the print head while the carriage performs scanning in the scanning direction,
wherein in the conveyance direction, a detection range of the detection unit overlaps a portion of an ejection range in which the liquid is ejected of a range in which the ejection port array is formed, and
during scanning by the carriage in a case where the detection unit detects the position of the end portion of the print medium, the control unit performs control so that the liquid is not ejected from an ejection port included in an area overlapping the detection range in the conveyance direction among the plurality of ejection ports constituting the ejection port array.

2. The printing apparatus according to claim 1, wherein an area of the print medium that is included in the area overlapping the detection range and corresponds to the ejection port from which the liquid is not ejected during the scanning by the carriage is printed with the print head during scanning subsequent to the scanning.

3. The printing apparatus according to claim 1, wherein in a case where the detection unit does not detect the position of the end portion of the print medium, the control unit controls the print head to eject the liquid from the plurality of ejection ports constituting the ejection port array and including the ejection port included in the area overlapping the detection range.

4. The printing apparatus according to claim 1, wherein in a case where the detection unit detects the position of the end portion of the print medium, the control unit controls the print head to eject the liquid from the plurality of ejection ports constituting the ejection port array and including the ejection port included in the area overlapping the detection range.

5. The printing apparatus according to claim 2, wherein the control unit controls the driving of the print head so that the liquid is ejected from the ejection port included in an area not overlapping the detection range of the detection unit in the conveyance direction among the plurality of ejection ports constituting the ejection port array.

6. The printing apparatus according to claim 1, wherein
the scanning direction includes a first direction and the detection unit is provided on a first-direction side of the carriage, and
the control unit causes the detection unit to detect the end portion of the print medium on the first-direction side in a case where the carriage is caused to perform scanning in the first direction.

7. The printing apparatus according to claim 6, wherein the detection unit comprises:
a first detection unit provided on a forward scanning direction side of the carriage; and
a second detection unit provided on a backward scanning direction side of the carriage, wherein the control unit causes
the first detection unit to detect a position of a first end portion of the print medium on the forward scanning direction side in a case where the carriage is caused to perform scanning in a forward scanning direction, and
the second detection unit to detect a position of a second end portion of the print medium on the backward scanning direction side in a case where the carriage is caused to perform scanning in a backward scanning direction.

8. The printing apparatus according to claim 1, wherein the control unit controls driving of the conveyance unit so that a conveyance amount by which the conveyance unit conveys the print medium is smaller than an amount of overlap between the detection range of the detection unit and the ejection range of the ejection port array in the conveyance direction.

9. The printing apparatus according to claim 7, wherein
in forward scanning or backward scanning by the carriage, the control unit controls the driving of the print head so that printing is performed for each of a plurality of areas obtained by dividing the plurality of ejection ports constituting the ejection port array in the conveyance direction, and
the control unit controls the detection unit so that in a case where printing is performed using an area not overlapping the detection range of the detection unit in the conveyance direction out of the plurality of areas, the detection unit detects the position of the end portion of the print medium.

10. The printing apparatus according to claim 8, wherein the control unit divides the plurality of ejection ports constituting the ejection port array into an upstream area and a downstream area in the conveyance direction and performs control to perform scanning using the upstream area and scanning using the downstream area.

11. The printing apparatus according to claim 1, wherein the control unit causes the detection unit to detect,
in a case where the carriage is caused to perform scanning in a first direction of the scanning direction, the end portion of the print medium on the first-direction side while performing printing with the print head, and,
in a case where the carriage is caused to perform scanning in a second direction of the scanning direction, the end portion of the print medium on a second-direction side without performing printing with the print head.

12. The printing apparatus according to claim 1, wherein a margin in the scanning direction from an end portion of a print area of the print medium where printing has been performed to the end portion of the print medium is 1.5 mm or less.

13. The printing apparatus according to claim 1, wherein the liquid is ink.

14. The printing apparatus according to claim 1, wherein the detection unit comprises a light emitting unit configured to irradiate light and a light receiving unit configured to receive reflected light of the light irradiated by the light emitting unit.

15. The printing apparatus according to claim 1, wherein the print head is configured to be detachable from the carriage.

16. The printing apparatus according to claim 1, wherein the control unit controls driving of the carriage and the driving of the print head so that the print head performs printing on the print medium without leaving any margin in the scanning direction on the print medium.

17. A printing apparatus comprising:
a conveyance unit configured to convey a print medium in a conveyance direction;
a carriage configured to perform scanning in a scanning direction intersecting the conveyance direction;
a print head mounted on the carriage and including an ejection port array in which a plurality of ejection ports for ejecting liquid are arranged in the conveyance direction to perform printing by ejecting the liquid from the ejection ports onto the print medium conveyed by the conveyance unit;
a detection unit provided on the carriage and configured to detect a position of an end portion of the print medium; and
a control unit configured to control driving of the conveyance unit,
wherein a detection range of the detection unit partially overlaps an ejection range in which the liquid is ejected of a range in which the ejection port array is formed, and
during scanning by the carriage in a case where the detection unit detects the position of the end portion of the print medium, the control unit controls the driving of the conveyance unit so that a conveyance amount by which the conveyance unit conveys the print medium is smaller than an amount of overlap between the detection range of the detection unit and the ejection range of the ejection port array in the conveyance direction.

18. The printing apparatus according to claim 17, wherein the control unit controls driving of the print head so that the liquid is ejected from all of the ejection ports constituting the ejection port array.

19. A printing apparatus comprising:
a conveyance unit configured to convey a print medium in a conveyance direction;
a carriage configured to perform scanning in a scanning direction intersecting the conveyance direction;
a print head mounted on the carriage and including an ejection port array in which a plurality of ejection ports for ejecting liquid are arranged in the conveyance direction to perform printing by ejecting the liquid from the ejection ports onto the print medium conveyed by the conveyance unit;
a detection unit provided on the carriage and configured to detect a position of an end portion of the print medium; and
a control unit configured to control driving of the detection unit and driving of the carriage,
wherein the control unit
performs control to perform printing for each of a plurality of areas obtained by dividing the plurality of ejection ports constituting the ejection port array in the conveyance direction in forward scanning or backward scanning by the carriage, and
controls the detection unit so that in a case where printing is performed using an area not overlapping a detection range of the detection unit in the conveyance direction among the plurality of areas, the detection unit detects the position of the end portion of the print medium.
